(19) United States
(12) Patent Application Publication
(10) Pub. No.: US 2003/0141967 A1
(43) Pub. Date: Jul. 31, 2003

(54) Automobile alarm system

(76) Inventors: Isao Aichi, Kariya-shi (JP); Yoshihisa Sato, Nagoya (JP)

Correspondence Address: POSZ & BETHARDS, PLC, 11250 ROGER BACON DRIVE, SUITE 10, RESTON, VA, 20190, US

(21) Appl. No.: 10/320,401

(22) Filed: Dec. 17, 2002

(30) Foreign Application Priority Data
Jan. 31, 2002 (JP) 2002-23866

(51) Int. Cl. B60Q 1/00

(52) U.S. Cl. 340/435; 340/691.1; 340/945

(57) ABSTRACT

An alarm system is provided which may be employed as an automotive anti-collision, a door safety system, etc. The alarm system works to detect a preselcted warning event associated with an automotive vehicle, determine a warning location where the warning event has occurred, and control outputs of speakers installed at different portions of the vehicle to produce a virtual sound source at the warning location so that a vehicle operator may perceive an alarm sound as being outputted from the virtual sound source and know the warning location correctly.

### BACKGROUND OF THE INVENTION

1. Technical Field of the Invention

The present invention relates generally to an automotive alarm system which works to output an alarm sound within a cabin of a vehicle, and more particularly to such a type of alarm system designed to produce a virtual sound source in a direction in which a preselected fault has occurred.

2. Background Art

Automotive alarm systems are known which work to turn on an alarm lamp installed within a cabin of a vehicle upon occurrence of incomplete locking of a passenger entry-exit door to inform a vehicle driver of that event or serve as anti-collision systems to sound an alarm when close proximity of a vehicle equipped with this system to other vehicles or any obstacles is detected through, for example, a clearance sonar.

Automotive alarm systems of the above types, however, have the drawback in that it is impossible to inform the driver instantly about a specific location of the fault. For instance, it is impossible for the former systems to pinpoint which door has been locked incompletely only by turning on the alarm lamp. In case of the anti-collision systems, it is impossible for the driver to instantly know a specific part of a vehicle body that is close approaching another vehicle only through the alarm sound.

### SUMMARY OF THE INVENTION

It is therefore a principal object of the invention to avoid the disadvantages of the prior art.

It is another object of the invention to provide an automotive alarm system designed to inform a vehicle occupant instantly of a specific location where a preselected warning event which causes an alarm signal to be outputted has occurred.

According to one aspect of the invention, there is provided an alarm system which may be employed in automotive vehicles as an anti-collision system, a door safety system, etc.. The alarm system comprises: (a) an alarm disposed within a cabin of the vehicle which works to output an alarm sound; (b) a warning event detector detecting a preselcted warning event associated with the vehicle to provide a warning signal indicative thereof; (c) a warning location determining circuit responsive to the warning signal from the warning event detector to determine a warning location where the warning event has occurred; and (d) an alarm controller controlling the alarm to produce a virtual sound source at the warning location as determined by the warning location determining circuit so that a vehicle occupant perceives the alarm sound as being outputted from the virtual sound source.

In the preferred mode of the invention, the alarm is made up of a plurality of sound outputting devices which are disposed at different locations within the cabin of the vehicle. The alarm controller works to actuate the sound outputting devices to output alarm sounds at the different locations to produce the virtual sound source at the warning location as determined by the warning location determining circuit.

The warning detector is designed to detect the warning event at each of predetermined different detecting locations of the vehicle. At least one of the detecting locations corresponds to one of the sound outputting devices. When the warning location determining circuit determines that the at least one of the detecting locations matches the warning location, the alarm controller controls outputs of the sound outputting devices so that the alarm sound produced by the one of the sound outputting devices reaches the occupant of the vehicle earlier than any other alarm sound.

When the warning location determining circuit determines that the at least one of the detecting locations matches the warning location, the alarm controller may control outputs of the sound outputting devices so that the alarm sound produced by the one of the sound outputting devices reaches the occupant of the vehicle at a sound pressure greater than that of any other alarm sound.

The warning detector may be designed to detect the warning event at each of a first, a second, and a third detecting locations of the vehicle. The first and second detecting locations correspond to two of the sound outputting devices. The third detecting location is defined between the first and second detecting locations. When the warning location determining circuit determines that the third detecting location matches the warning location, the alarm controller controls the outputs of the two of the sound outputting devices so that the alarm sounds produced by the two of the sound outputting devices reach the occupant of the vehicle simultaneously, thereby producing the virtual sound source at the third detecting location.

The alarm controller may control the outputs of the two of the sound outputting devices so that the sound alarms produced by the two of the sound outputting devices reach the occupant at the same sound pressure.

The sound outputting devices may be installed at two locations on right and left sides of the occupant, respectively. The alarm controller controls the outputs of the sound outputting devices produced at the two locations so as to establish the virtual sound source at the warning location.

The two locations at which the sound outputting devices are installed may be defined behind a head of the occupant sitting on a seat of the vehicle.

The controller may include a memory storing therein sound data for producing the virtual sound source at each of different portions of the vehicle, a selecting circuit selecting one of the sound data corresponding to the warning location, and a virtual sound source producing circuit working to control the alarm so as to output the alarm sound based on the selected sound data, thereby producing the virtual sound source at the warning location.

The sound data stored in the memory may be made up of digital signal series.

The alarm controller may include a signal processing circuit responsive to the signal outputted from the warning detector to perform a given signal processing operation to output an alarm signal. The alarm is responsive to the signal outputted from the signal processing circuit to output the alarm sound, thereby producing the virtual sound source at the warning location.

The signal processing circuit may perform the signal processing operation in a digital form. For example, the signal processing operation performed by the signal processing circuit is a filtering operation. The signal processing circuit includes a memory storing therein filter coefficients for producing the virtual sound source at each of different portions of the vehicle, a selecting circuit selecting one of the filter coefficients corresponding to the warning location, and a filtering circuit performing the filtering operation on the selected filter coefficient to output the alarm signal to the alarm.

The warning event detector may be implemented by an obstacle detector which works to track an obstacle existing around the vehicle and produce the warning signal.

The obstacle detector may include a transceiver which transmits a signal wave around the vehicle and receives a return of the signal wave from the obstacle and a detecting circuit which measures a time the signal wave takes to travel to and return from the obstacle to detect the obstacle.

When the detecting circuit detects the obstacle, the warning location determining circuit determines a mount location where the transceiver is mounted on the vehicle as the warning location. The alarm controller controls the alarm to produce the virtual sound source at the mount location of the transceiver.

The warning event detector may alternatively include a door sensor working to monitor an opened state of each of doors of the vehicle and a warning event determining circuit determines that the warning event has occurred when the opened state meets a given condition.

When the warning event determining circuit determines that the warning event has occurred, the warning location determining circuit determines a location of one of the doors meeting the given condition as the warning location. The alarm controller controls the alarm to produce the virtual sound source at the location of the one of the doors.

The warning event detector may alternatively include a tire air pressure sensor working to monitor a pressure of air in each of inflatable tires of the vehicle and a warning event determining circuit determines that the warning event has occurred when the monitored pressure drops below a given level.

When the warning event determining circuit determines that the warning event has occurred, the warning location determining circuit determines a location of one of the tires determined to drop in the pressure below the given level as the warning location. The alarm controller controls the alarm to produce the virtual sound source at the location of the one of the tires.

The alarm controller may be designed to output an alarm control signal to the alarm and include a signal combiner working to combine the alarm control signal and an output of an audio device installed in the vehicle to produce a sound signal whereby the alarm reproduces the sound signal.

### BRIEF DESPCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which shows an automotive alarm system according to the first embodiment of the invention which is employed as an anti-collision system;

FIG. 2 is an illustration which shows locations of sensors and speakers in a vehicle;

FIG. 3 is a sonar output-to-address translation table listing sensor signals and their corresponding addresses;

FIG. 4 is an address-to-signal series translation table listing addresses and their corresponding digital signal series for each speaker;

FIG. 5 is a flowchart of a program executed to produce a virtual sound source at a desired location;

FIGS. 6(a), 6(b), 6(c), and 6(d) show sine waves to be produced as alarm sounds by front right, front left, rear right, and rear left speakers in order to produce a virtual sound source at a right rearward location;

FIGS. 7(a), 7(b), 7(c), and 7(d) show sine waves to be produced as alarm sounds by front right, front left, rear right, and rear left speakers in order to produce a virtual sound source at a central rearward location;

FIGS. 8(a), 8(b), 8(c), and 8(d) show sine waves to be produced as alarm sounds by front right, front left, rear right, and rear left speakers in order to produce a virtual sound source at a left rearward location;

FIGS. 9(a), 9(b), 9(c), and 9(d) show sine waves to be produced as alarm sounds by front right, front left, rear right, and rear left speakers in order to produce a virtual sound source at a right frontward location;

FIGS. 10(a), 10(b), 10(c), and 10(d) show sine waves to be produced as alarm sounds by front right, front left, rear right, and rear left speakers in order to produce a virtual sound source at a left frontward location;

FIG. 11 is a block diagram which shows an automotive alarm system according to the second embodiment of the invention;

FIG. 12 is an address-to-filter coefficient translation table listing addresses and their corresponding filter coefficients as used in the alarm system of FIG. 11;

FIG. 13 is an illustration which shows transfer functions of an alarm sound within a vehicle;

FIG. 14 is a flowchart of a program executed by the alarm system of FIG. 11 to produce a virtual sound source at a desired location;

FIG. 15 is a block diagram which shows an automotive alarm system according to the third embodiment of the invention; and

FIG. 16 is an illustration which shows locations of sensors and speakers in the alarm system of FIG. 15.

### DESCRIPTION OF THE PREFERRED EMBODIMENTS

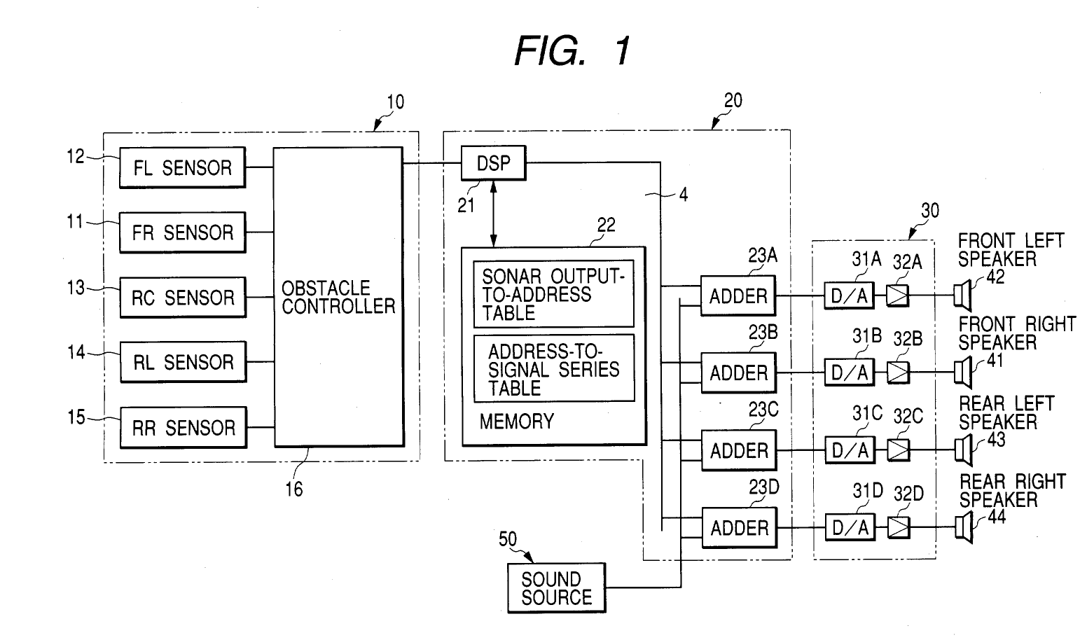

Referring to the drawings, wherein like reference numbers refer to like parts in several views, particularly to FIG. 1, there is shown an automotive alarm system according to the invention which works as an obstacle detecting system to output an alarm signal upon detection of any obstacle around a vehicle equipped with this system (will also be referred to as a system vehicle below).

The alarm system includes a clearance sonar 10, an alarm controller 20, a speaker driver 30, four speakers: front left, front right, rear left, and rear right speakers 42, 41, 43, and 44, and a sound source 50. The clearance sonar 10 is made up of five corner sensors (CSs): a front right sensor 11, a front left sensor 12, a rear center sensor 13, a rear left sensor 14, a rear right sensor 15, and an obstacle controller 16.

The sensors 11 to 15 are each controlled by the obstacle controller 16 to transmit a radar wave such as an ultrasonic wave, an infrared ray, or a millimeter wave, receive a return thereof from any obstacle such as a vehicle running around the system vehicle or a guard rail, and provide a signal indicative thereof to the obstacle controller 16. The obstacle controller 16 monitors an output from each of the sensors 11 to 15 and determines the presence or absence of an obstacle within a given radar range embracing the system vehicle. Details of operations of the sensors 11 to 15 and the obstacle controller 16 will be described later.

The alarm controller 20 consists of a digital signal processor (DSP) 21, and a memory 22, adders 23A to 23D. The DSP 21 works to establish a virtual sound source at a specific location (will also be referred to as an obstacle-detecting sensor location below) of one of the sensors 11 to 15 detecting an obstacle. The memory 22 stores therein a sonar output-to-address translation table and an address-to-signal series translation table in addition to a computer program. Details of the sonar output-to-address translation table and the address-to-signal series translation table will be described later.

The adders 23A to 23D are provided, one for each of the speakers 41 to 44, and each work to add a sonar output from the DSP 21 to an output from the sound source 50 to produce a composite signal. The speaker driver 30 is made up of digital-to-analog converters 31A to 31D and amplifiers 32A to 32D. Each of the D/A converters 31A to 31D converts an output of a corresponding one of the adders 23A to 23D into an analog signal and outputs it to a corresponding one of the amplifiers 32A to 32D. The amplifiers 32A to 32D amplify in power the outputs of the D/A converters 31A to 31D. Each of the speakers 41 to 44 is connected to a corresponding one of the amplifiers 32A to 32D and works to output an alarm sound. The sound source 50 includes an audio device such as a radio tuner, a CD, or a MD player and works to output an audio signal to the adders 23A to 23D.

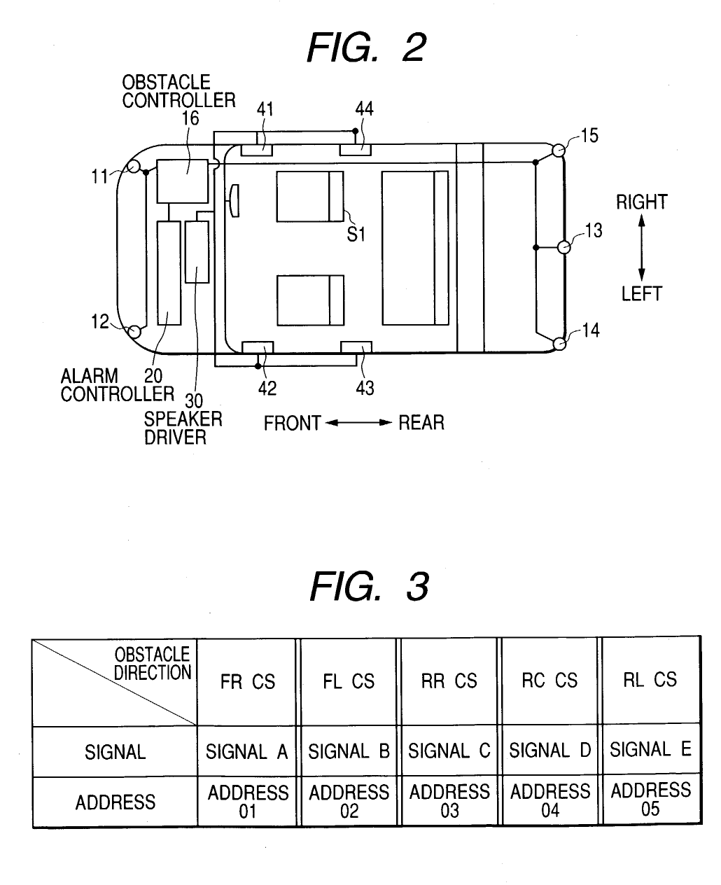

Functions of the sensors 11 to 15 and the obstacle controller 16 of the clearance sonar 10 will be described below with reference to FIG. 2.

The front right sensor 11 is installed on a right portion (also referred to as a first detecting location below) of the front of a vehicle body and works to transmit a radar wave in a right forward direction of the vehicle. The front left sensor 12 is installed on a left portion (also referred to as a second detecting location below) of the front of the vehicle body and works to transmit a radar wave in a left forward direction of the vehicle. The rear center sensor 13 is installed on the center (also referred to as a third detecting location below) of the rear of the vehicle body and works to transmit a radar wave right behind the vehicle body. The rear left sensor 14 is installed on a left portion of the rear of the vehicle body and works to transmit a radar wave in a left rearward direction of the vehicle body. The rear right sensor 15 is installed on a right portion of the rear of the vehicle body and works to transmit a radar wave in a right rearward direction of the vehicle body. Specifically, the sensors 11 to 15 are installed on different portions of the vehicle body and work to output the radar waves in different directions.

The obstacle controller 16 measures the time the radar wave outputted from each of the sensors 11 to 15 takes to travel to and return from an obstacle existing within the radar range and determines whether the measured time is longer than a preselected time or not. If it is determined that the measured time is shorter than the preselected time, the obstacle controller 16 concludes that the obstacle is approaching the system vehicles and produce as the sonar output one of signals A to E as a function of the directions of the obstacle.

The speakers 42 to 44 are installed at locations different from those of the sensors 11 to 15. Specifically, the front right speaker 41 is disposed on an inner wall of a front right door of the vehicle body and faces inside the cabin. Similarly, the front left speaker 42, the rear left speaker 43, and the rear right speaker 44 are disposed on inner walls of the front left, rear left, and rear right doors, respectively, and face inside the cabin. The speakers 41, 42, 43, and 44 are paired with the sensors 11, 12, 14, and 15, respectively.

The memory 22, as described above, stores therein the sonar output-to-address translation table and the address-to-signal series translation table. The sonar output-to-address translation table, as shown in FIG. 3, lists therein the signals A to E (i.e., the sonar outputs) and their corresponding memory addresses 01, 02, 03, 04, and 05 with one-to-one correspondence. In the following discussion, each of the memory addresses 01 to 05 will generally be referred to as an address OZ (Z=1 to 5).

Specifically, the addresses 01 to 05 are allocated to the front right sensor 11, the front left sensor 12, the rear right sensor 15, the rear center sensor 13, and the rear left sensor 14, respectively.

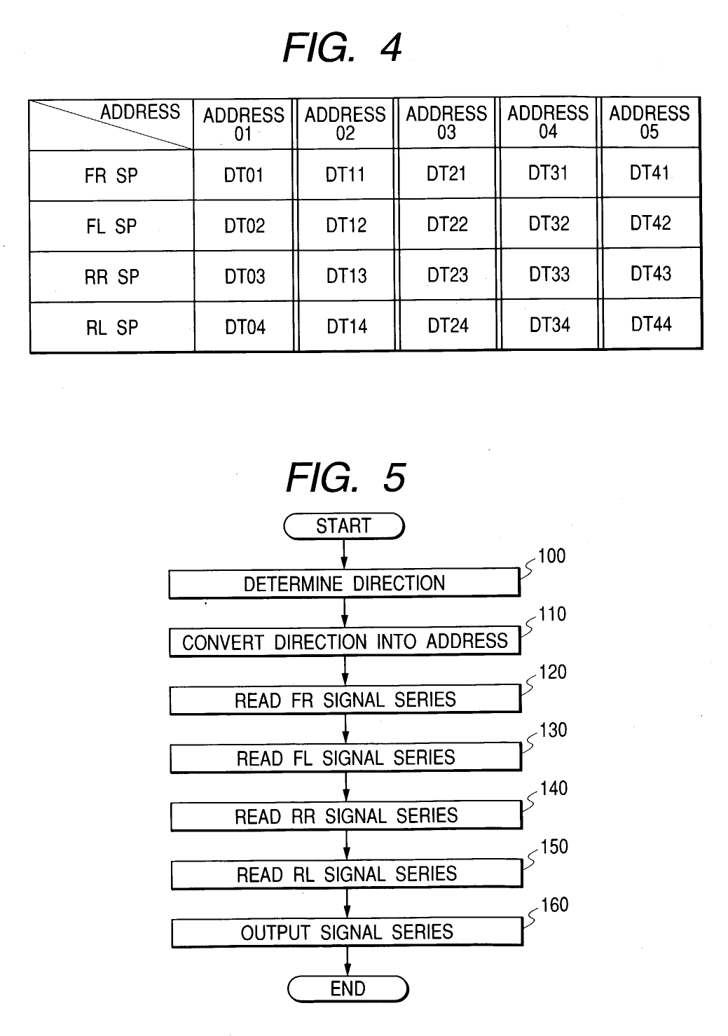

The address-to-signal series translation table, as clearly shown in FIG. 4, lists addresses 01 to 05 and their corresponding digital signal series DT01 to DT44 as prepared four for each of the addresses 01 to 05. Specifically, a set of four of the digital signal series DT01 to DT44 corresponding to four speakers: the front right speaker 41, the front left speaker 42, the rear left speaker 43, and the rear right speaker 44 is selected for each of the addresses 01 to 05.

Each of the digital signal series DT01 to DT44 is an audio sine wave signal series for producing an alarm sound. The digital signal series each have a preselected time lag (i.e., a phase angle) and amplitude level, as will be described later in detail, required for producing a virtual sound source at a location of one of the sensors 11 to 15 having detected an obstacle.

In the following discussion, five of the digital signal series DT01 to DT44 to which the addresses 01 to 05 are allocated, respectively, will generally be referred to as DT0X, DT1X, DT2X, DT3X, and DT4X, respectively, where X indicates one of one (1) to four (4).

FIG. 5 shows a flowchart of a sequence of logical steps or program which is stored in the memory 22 and executed by the DSP 21 upon turning on of an ignition switch of the system vehicle.

After entering the program, the routine proceeds to step 100 wherein the location of one of the sensors 11 to 15 detecting an obstacle, that is, the direction of the obstacle tracked by this system is determined by monitoring the sonar output from the obstacle controller 16 of the clearance sonar 10 to determine which of the signals A to E is the sonar output.

The routine proceeds to step 110 wherein one of the addresses 01 to 05 allocated to the one of the signals A to E determined in step 100 is selected by look-up using the sonar output-to-address translation table, as shown in FIG. 4.

The routine proceeds to step 120 wherein one of the digital signal series DT01 to DT44 for the front right speaker 41 to which the one of the addresses 01 to 05 as determined in step 110 is allocated is selected by look-up using the address-to-digital signal series translation table, as shown in FIG. 4. Similar operations are performed in steps 130 to 150 to derive three of the digital signal series DT01 to DT44 for the front left speaker 42, the rear right speaker 44, and the rear left speaker 43 to which the one of the addresses 01 to 05 as determined in step 110 is allocated are selected. In the following discussion, four of the digital signal series DT01 to DT44 for the respective speakers 41 to 44 will generally be referred to as DTk1 to DTk4 (0≦k≦4).

The routine proceeds to step 160 wherein the digital signal series DTk1 as selected in step 120 for the front right speaker 41 is outputted to the D/A converter 31B through the adder 23B. Similarly, digital signal series DTk2 to DTk4 as selected in steps 130 to 150 for the front left speaker 42, the rear right speaker 44, and the rear left speaker 43 are outputted to the D/A converters 31A, 31D, and 31C through the adders 23A, 23D, and 23C, respectively.

The D/A converter 31B converts the digital signal series DTk1 into an analog signal and outputs it to the front right speaker 41 through the amplifier 32B. This causes the front left speaker 41 to output an alarm sound as produced by the digital signal series DTk1. Similarly, the D/A converters 31A, 31C, and 31D convert the digital signal series DTk2, DTk4, and DTk3 into analog signals and output them to the front left speaker 42, the rear left speaker 43, and the rear right speaker 44, respectively. This causes the front left speaker 42, the rear left speaker 43, and the rear right speaker 44 to output alarm sounds as produced by the digital signal series DTk2, DTk4, and DTk3, respectively.

The digital signal series DTk1 to DTk4 have time lags and amplitude levels, respectively, required for producing a virtual sound source at a location of one of the sensors 11 to 15 having detected an obstacle. This causes an occupant, e.g., a driver of the system vehicle to perceive the alarm sound as generated from a direction in which one of the sensors 11 to 15 detecting the obstacle is disposed.

Several examples where the sensors 11 to 15 have detected obstacles in different directions will be described below.

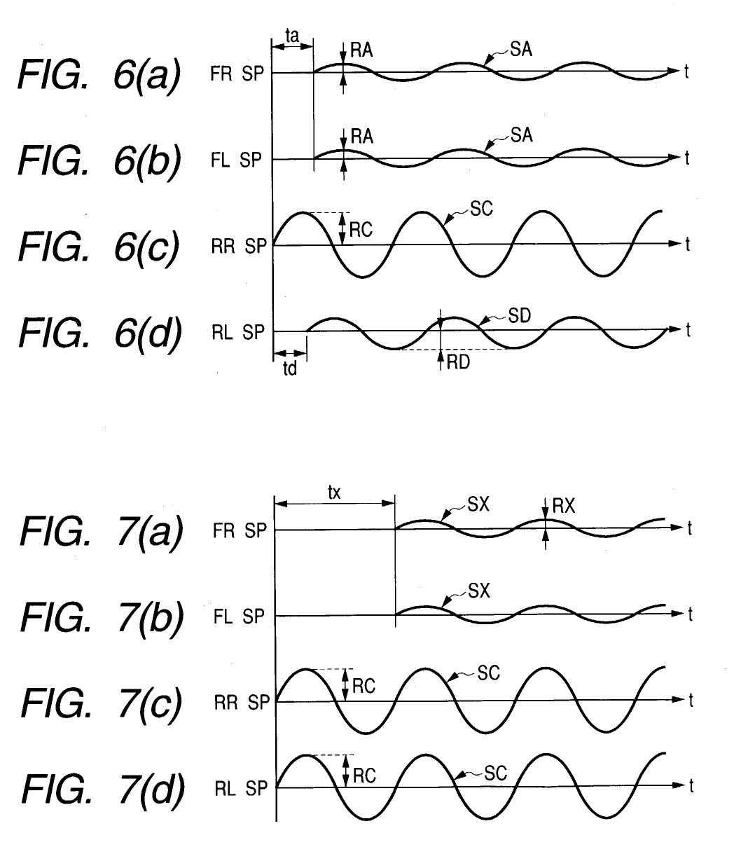

If the rear right sensor 15 has detected an obstacle, the clearance sonar 10 outputs the signal C. The alarm controller 20 selects the address 03 and the digital signal series DT2X. The D/A converters 31B, 31A, 31D, and 31C converts the digital signal series DT21, DT22, DT23, and DT24 into sine wave signals SA, SC, and SD, as shown in FIGS. 6(a) to 6(d). Specifically, the rear right speaker 44 outputs the sine wave SC, as shown in FIG. 6(c), having the amplitude RC. The rear left speaker 43 outputs the sine wave SD, as shown in FIG. 6(d), a time td (≦0.1 msec.) after the sine wave SC. The front right and left speakers 41 and 42 output the same sine wave SA a time ta (td≦ta≦0.1 msec.) after the sine wave SC. This causes the output of the rear right speaker 44 reaches the occupant of the system vehicle earlier than those of the rear left speaker 43, the front right speaker 41, and the front left speaker 42, so that the occupant perceives a virtual sound source on the side of the rear right sensor 15 (i.e., the rear right speaker 44).

The amplitude RC of the output of the rear right speaker 44 is greater than the amplitude RD of the rear left speaker 43, so that the output of the rear right speaker 44 reaches the occupant at a sound pressure greater than that of the rear left speaker 43, thereby causing the occupant to feel the alarm sound clearly to be being outputted from the direction of the rear right sensor 15.

The alarm sounds are also outputted from the front right speaker 41 and the front left speaker 42, thus, the sound pressure reaching the occupant from the rear right speaker 44 to be raised. Specifically, the amplitude SA of the outputs of the front right speaker 41 and the front left speaker 42 is lower than the amplitudes SC and SD of the outputs of the rear right speaker 44 and the rear left speaker 43, so that the occupant perceive the alarm sound outputted from the side of the rear right sensor 15 clearly at all times.

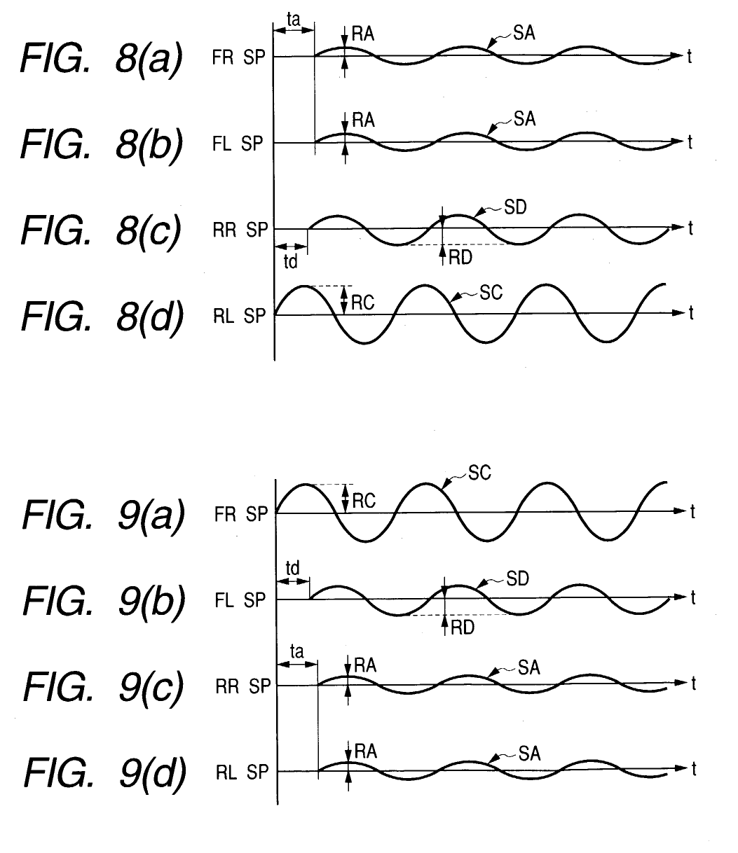

If the rear center sensor 13 has detected an obstacle, the clearance sonar 10 outputs the signal D. The alarm controller 20 selects the address 04 and the digital signal series DT3X. The D/A converters 31B, 31A, 31D, and 31C converts the digital signal series DT31, DT32, DT33, and DT34 into sine wave signals SX and SC, as shown in FIGS. 7(a) to 7(d). Specifically, the rear right speaker 44 and the rear left speaker 43, as shown in FIGS. 7(c) and 7(d), output the same wave SC as in FIG. 6(c). Specifically, the rear right speaker 44 and the rear left speaker 43 output the sine waves SC that are identical in phase angle and amplitude with each other, so that the outputs of the rear right speaker 44 and the rear left speaker 43 reach the occupant simultaneously at the same sound pressure. This causes the occupant to feel the alarm sound to be being outputted from a virtual sound source provided at the location of the rear center sensor 13 (i.e., the third detecting location).

The distance between the occupant and the rear right speaker 44 may be different from that between the occupant and the rear left speaker 43 depending upon arrangements of the speakers 41 to 44 and the sensors 11 to 15. Thus, in order to have the outputs of the rear right speaker 44 and the rear left speaker 43 reach the occupant simultaneously, it is advisable that a time difference between the outputs of the speakers 44 and 43 be provided as a function of the above distance difference.

The front right and left speakers 41 and 42 output the same sine wave SX a time tx (≦0.1 msec.) after the sine wave SC. The amplitude RX of the since waves SX is lower than the amplitude RC of the since waves SC. This causes the occupant to feel the alarm sound to be being outputted from right behind of the system vehicle at all times.

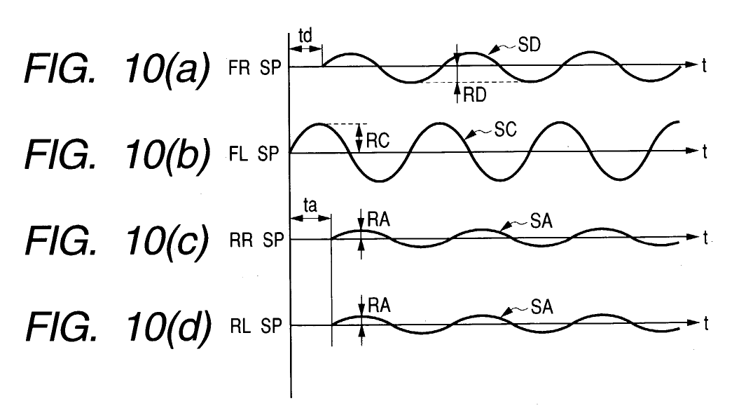

If the rear left sensor 14 has detected an obstacle, the clearance sonar 10 outputs the signal E. The alarm controller 20 selects the address 05 and the digital signal series DT4X. The D/A converters 31B, 31A, 31D, and 31C converts the digital signal series DT41, DT42, DT43, and DT44 into sine wave signals SA, SD, and SC, as shown in FIGS. 8(a) to 8(d). Specifically, the rear left speaker 43 outputs, as shown in FIG. 8(d), the sine wave SC identical with the one shown in FIG. 6(c). The rear right speaker 44 outputs, as shown in FIG. 8(c), the sine wave SD which is identical with the one in FIG. 6(d) the time td after the sine wave SC. The front right and left speakers 41 and 42 output the sine wave SA which is identical with the one in FIGS. 6(a) and 6(b) the time ta after the sine wave SC. This causes the output of the rear left speaker 43 reaches the occupant earlier than those of the rear right speaker 44, the front right speaker 41, and the front left speaker 42, so that the occupant perceives a virtual sound source on the side of the rear left sensor 14.

The alarm sounds are also outputted from the front right speaker 41 and the front left speaker 42, thus, the sound pressure reaching the occupant from the rear left speaker 43 to be raised. Specifically, the amplitude SA of the outputs of the front right speaker 41 and the front left speaker 42 is lower than the amplitudes SC and SD of the outputs of the rear left speaker 43 and the rear right speaker 44, so that the occupant perceive the alarm sound outputted from the side of the rear left sensor 14 clearly at all times.

If the front right sensor 11 has detected an obstacle, the clearance sonar 10 outputs the signal A. The alarm controller 20 selects the address 01 and the digital signal series DT0X. The D/A converters 31B, 31A, 31D, and 31C converts the digital signal series DT01, DT02, DT03, and DT04 into sine wave signals SC, SD, and SA, as shown in FIGS. 9(a) to 9(d). Specifically, the front right speaker 41 outputs, as shown in FIG. 9(a), the sine wave SC identical with the one in FIG. 6(c). The front left speaker 42 outputs, as shown in FIG. 9(b), the sine wave SD identical with the one in FIG. 6(d) the time td after the sine wave SC. The rear right and left speakers 44 and 43 output, as shown in FIGS. 9(c) and 9(d), the sine wave SA the time ta after the sine wave SC. This causes the output of the front right speaker 41 reaches the occupant of the system vehicle earlier than those of the front left speaker 42, the rear right speaker 44, and the rear left speaker 43, so that the occupant perceives a virtual sound source on the side of the front right sensor 11.

The alarm sounds are also outputted from the rear right speaker 44 and the rear left speaker 43, thus, the sound pressure reaching the occupant from the front right speaker 41 to be raised. Specifically, the amplitude SA of the outputs of the rear right speaker 44 and the rear left speaker 43 is lower than the amplitudes SC and SD of the outputs of the front right speaker 41 and the front left speaker 42, so that the occupant perceive the alarm sound outputted from the side of the front right sensor 11 clearly at all times.

If the front left sensor 12 has detected an obstacle, the clearance sonar 10 outputs the signal B. The alarm controller 20 selects the address 02 and the digital signal series DT1X. The D/A converters 31B, 31A, 31D, and 31C converts the digital signal series DT11, DT12, DT13, and DT14 into sine wave signals SD, SC, and SA, as shown in FIGS. 10(a) to 10(d). Specifically, the front left speaker 42 outputs, as shown in FIG. 10(b), the sine wave SC identical with the one in FIG. 6(c). The front right speaker 41 outputs, as shown in FIG. 10(a), the sine wave SD identical with the one in FIG. 6(d) the time td after the sine wave SC. The rear right and left speakers 44 and 43 output, as shown in FIGS. 10(c) and 10(d), the sine wave SA the time ta after the sine wave SC. This causes the output of the front left speaker 42 reaches the occupant earlier than those of the front right speaker 41, the rear right speaker 44, and the rear left speaker 43, so that the occupant perceives a virtual sound source on the side of the front left sensor 12.

The alarm sounds are also outputted from the rear right speaker 44 and the rear left speaker 43, thus, the sound pressure reaching the occupant from the front left speaker 42 to be raised. Specifically, the amplitude SA of the outputs of the rear right speaker 44 and the rear left speaker 43 is lower than the amplitudes SD and SC of the outputs of the front right speaker 41 and the front left speaker 42, so that the occupant perceive the alarm sound outputted from the side of the front left sensor 12 clearly at all times.

As apparent from the above discussion, the alarm system of this embodiment works to control the outputs of the respective speakers 41 to 44 so as to produce the virtual sound source at a location of one of the sensors 11 to 15 acquiring an object existing forward or backward of the system vehicle, thereby having a vehicle occupant, e.g., a driver perceive a specific direction of the acquired obstacle acoustically.

The adders 23A to 23D add the sonar outputs from the DSP 21 to an output of the sound source 50 such as a radio tuner, a CD, or a MD player to produce composite signals, respectively. The speaker driver 30, thus, works to output the alarm sound and music simultaneously as needed through the speakers 41 to 44. Specifically, the alarm system shares the speaker driver 30 and the speakers 41 to 44 with an audio system including the sound source 50, thus resulting in a decrease in manufacturing cost.

The production of the virtual sound source at a desired location is achieved by providing the lag times td, ta, and tx and a difference in amplitude between the outputs of the speakers 41 to 44, but however, it may also be achieved only by using either of them.

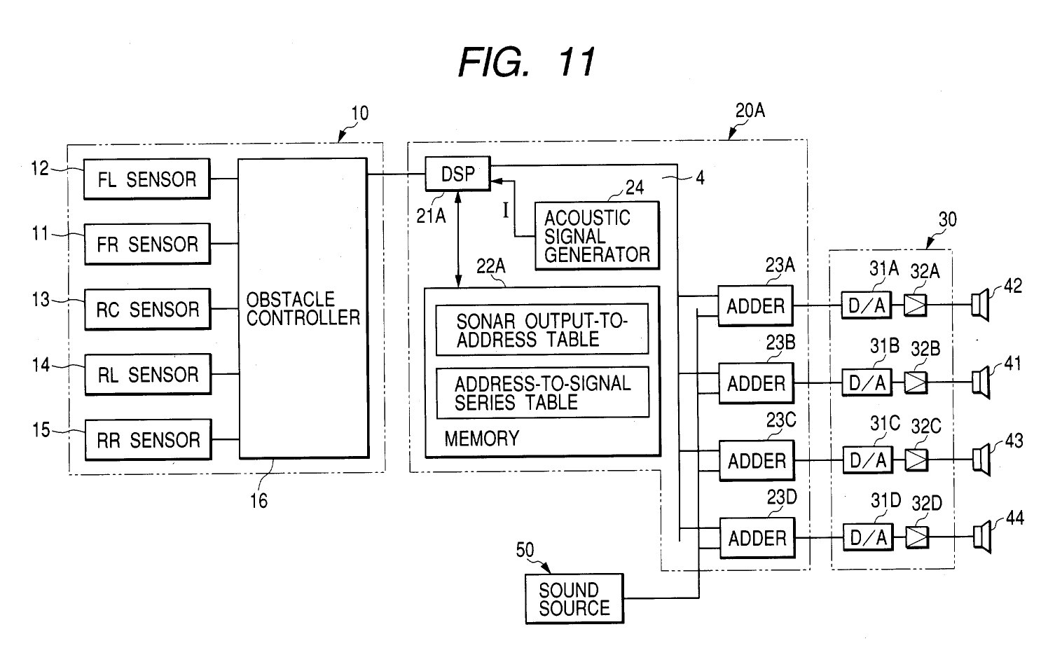

FIG. 11 shows an automotive alarm system according to the second embodiment which is different from the first embodiment in that the sine wave signals outputted to the adders 23A to 23D are produced by filtering.

The alarm system includes the clearance sonar 10, the alarm controller 20A, the speaker driver 30, the four speaker 41 to 44, and the sound source 50. The same reference numbers as employed in the first embodiment will refer to the same parts, and explanation thereof in detail will be omitted here.

The alarm controller 20A includes the DSP 21A, the memory 22A, and the acoustic signal generator 24. The DSP 21A works to perform, as described later in detail, a filtering operation in a digital form to produce the virtual sound source at a location of one of the sensors 11 to 15 detecting an obstacle. The acoustic signal generator 24 is made of a memory storing therein a frequency signal I having a single frequency.

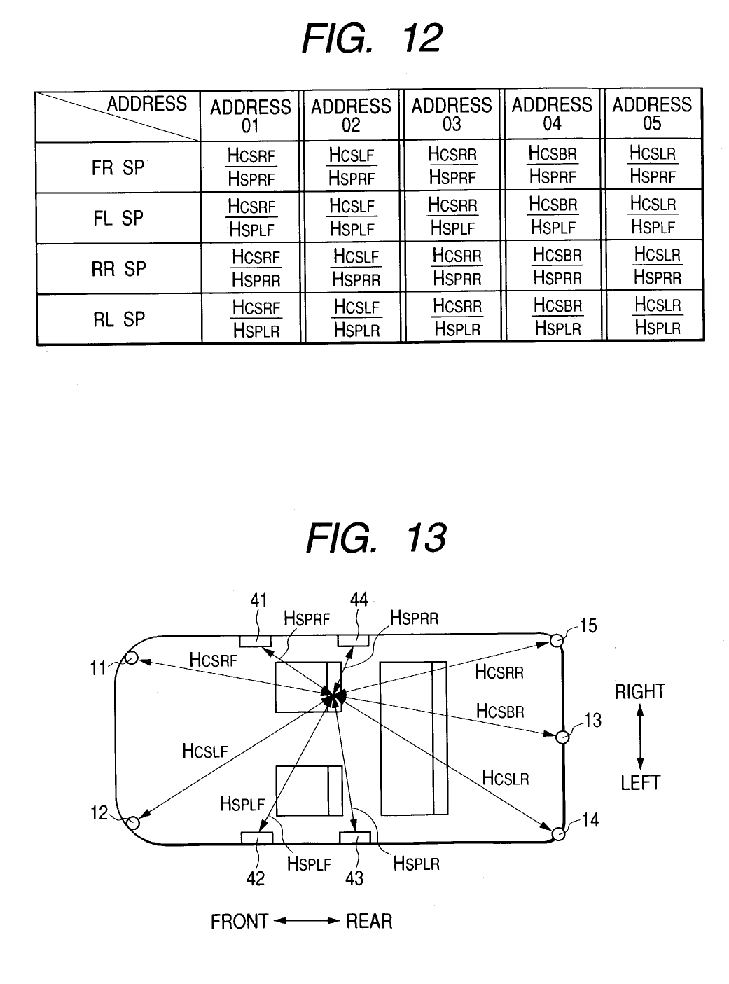

The memory 22A stores therein a sonar output-to-address translation table and an address-to-signal series translation table in addition to a computer program. The sonar output-to-address translation table is the same as the one shown in FIG. 3. The address-to-signal series translation table lists, as shown in FIG. 12, addresses 01 to 05 and their corresponding filter coefficients HcsRF/HspRF to HcsLR/HspLR as prepared four for each of the addresses 01 to 05. Specifically, a set of four of the filer coefficients corresponding to four speakers: the front right speaker 41, the front left speaker 42, the rear left speaker 43, and the rear right speaker 44 is selected for each of the addresses 01 to 05.

Each of the filter coefficients HcsRF/HspRF to HcsLR/HspLR works to determine a lag time and amplitude level of the frequency signal for producing the digital signal series DT01 to DT44 as described in the first embodiment.

Each of the filter coefficients HcsRF/HspRF to HcsLR/HspLR is determined, as shown in FIG. 13, by a combination of one of transfer functions HcsRF to HcsLR of the alarm sound transferred from a corresponding one of the speakers 41 to 44 to the occupant and one of transfer functions HspRF to HspLR of the alarm sound transferred from a corresponding one of the sensors 11 to 15 to the occupant. The transfer function HcsRF is a transfer function of the alarm sound between the front right sensor 11 and the occupant. The transfer function HcsLF is a transfer function of the alarm sound between the front left sensor 12 and the occupant. The transfer function HcsRR is a transfer function of the alarm sound between the rear right sensor 15 and the occupant. The transfer function HcsBR is a transfer function of the alarm sound between the rear center sensor 13 and the occupant. The transfer function HcsLR is a transfer function of the alarm sound between the rear left sensor 14 and the occupant. The transfer function HspRF is a transfer function of the alarm sound between the front right speaker 41 and the occupant. The transfer function HspLF is a transfer function of the alarm sound between the front left speaker 42 and the occupant. The transfer function HspRR is a transfer function of the alarm sound between the rear right speaker 44 and the occupant. The transfer function HspLR is a transfer function of the alarm sound between the rear left speaker 43 and the occupant.

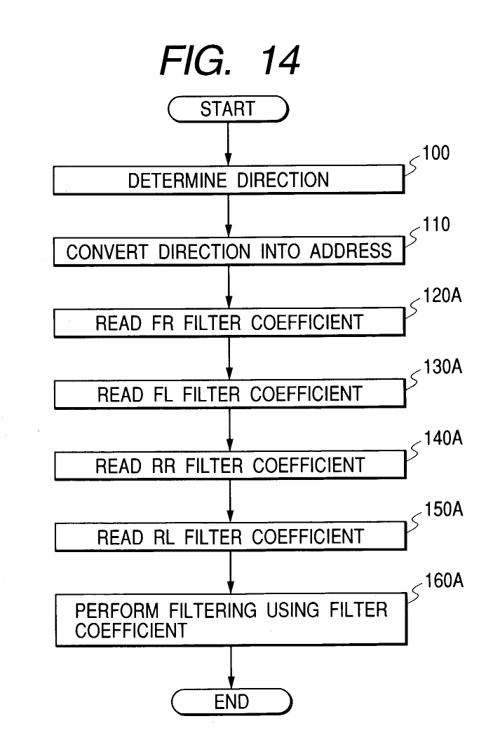

FIG. 14 shows a flowchart of a sequence of logical steps or program which is executed by the DSP 21A upon turning on of an ignition switch of the system vehicle.

After entering the program, the routine proceeds to step 100 wherein the location of one of the sensors 11 to 15 detecting an obstacle, that is, the direction of the obstacle tracked by this system is determined by monitoring the sonar output from the obstacle controller 16 of the clearance sonar 10 to determine which of the signals A to E is the sonar output.

The routine proceeds to step 110 wherein one of the addresses 01 to 05 allocated to the one of the signals A to E determined in step 100 is selected by look-up using the sonar output-to-address translation table, as shown in FIG. 4.

The routine proceeds to step 120A wherein one of the filter coefficients for the front right speaker 41 to which the one of the addresses 01 to 05 as determined in step 110 is allocated is selected by look-up using the address-to-filter coefficient translation table, as shown in FIG. 12. Similar operations are performed in steps 130A to 150A to derive three of the filter coefficients for the front left speaker 42, the rear right speaker 44, and the rear left speaker 43 to which the one of the addresses 01 to 05 as determined in step 110 is allocated are selected. In the following discussion, four of the filter coefficients for the speakers 41 to 44 will generally be referred to as FL, FR, RL, and RR, respectively.

The routine proceeds to step 160A wherein the frequency signal I is acquired from the acoustic signal generator 24 to perform the digital filtering operation using the filter coefficients FL, FR, RL, and RR. Specifically, the filter coefficient FL is convoluted by the frequency signal I to output a filter output (FL·I) to the adder 23A. The filter output (FL·I) is substantially identical with the digital signal series DTk1 as described above. The adder 23A, the D/A converter 31A, the amplifier 32A, and the speaker 42, thus, operate in the same manners as described in the first embodiment.

Similarly, the filter coefficient FR is convoluted by the frequency signal I to output a filter output (FR·I) to the adder 23B. The filter coefficient RL is convoluted by the frequency signal I to output a filter output (RL·I) to the adder 23C. The filter coefficient RR is convoluted by the frequency signal I to output a filter output (RR·I) to the adder 23D. The filter outputs (FR·I), (RL·I), and (RR·I) are substantially identical with the digital signal series DTk2 to DTk4 as described above. The adders 23B to 23D, the D/A converters 31B to 31D, the amplifiers 32B to 32D, and the speakers 41 to 44, thus, operate in the same manners as described in the first embodiment.

As apparent from the above discussion, the alarm system of this embodiment works to perform the digital filtering operation to produce the same digital signal series DTk1 to DTk4 as those in FIG. 4, thereby establishing the virtual sound source at a location of one of the sensors 11 to 15 acquiring an object existing forward or backward of the system vehicle, thereby having a vehicle occupant, e.g., a driver perceive a specific direction of the acquired obstacle acoustically.

Instead of the digital filtering operation, a typical analog filtering operation may be used. Further, a variety of signal processing operations other than the filtering operation may alternatively be used.

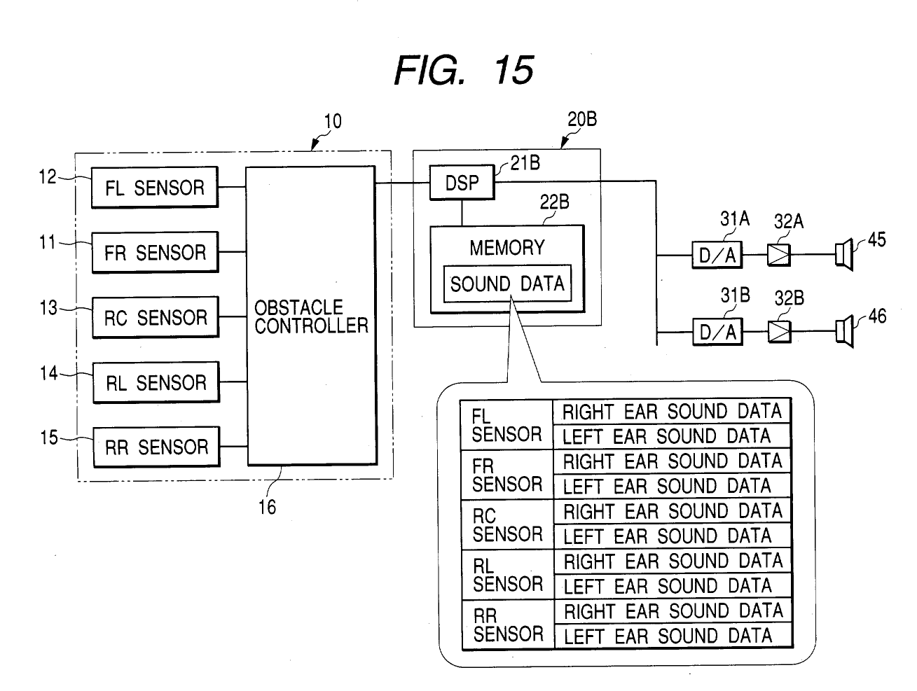

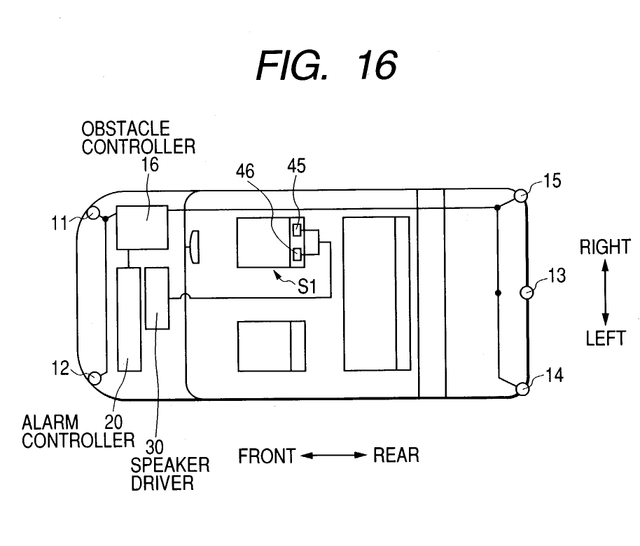

FIG. 15 shows an automotive alarm system according to the third embodiment of the invention which is designed to produce the virtual sound source at a location of each of the sensors 11 to 15 through two speakers using the known stereo dipole techniques.

The alarm system includes the clearance sonar 10, the alarm controller 20B, the D/A converters 31A and 31B, the amplifiers 32A and 32B,and the left speaker 45 and the right speaker 46. The same reference numbers as employed in FIG. 15 will refer to the same parts, and explanation thereof in detail will be omitted here.

The alarm controller 20B includes the DSP 21B and the memory 22B. The memory 22B stores therein sound data made up of right ear sound data and left ear sound data for the front right sensor 11, the front left sensor 12, the rear center sensor 13, the rear left sensor 14, and the rear right sensor 15.

The right ear sound data is a digital signal series for producing an alarm sound entering the right ear of the occupant from a direction of each of the sensors 11 to 15. The left ear sound data is a digital signal series for producing an alarm sound entering the left ear of the occupant from a direction of each of the sensors 11 to 15. The right and left ear sound data are derived experimentally.

The DSP 21B of the alarm controller 20B reads the right and left ear sound data out of the memory 22B which correspond to the sonar output from the clearance sonar 10 and outputs them to the D/A converters 31A and 13B, respectively.

The D/A converter 31A converts the right ear sound data provided for each of the sensors 11 to 15 into an analog signal and outputs it to the right speaker 45 through the amplifier 32A. Similarly, the D/A converter 31B converts the left ear sound data provided for each of the sensors 11 to 15 into an analog signal and outputs it to the left speaker 46 through the amplifier 32B. The right speaker 46 outputs an alarm sound as produced by the right ear sound data. The left speaker 46 outputs an alarm sound as produced by the left ear sound data.

The right speaker 46 is, as clearly shown in FIG. 16, installed in a right side of a headrest of a driver's seat S1. The left speaker 46 is installed in a left side of the headrest. Specifically, the right and left speakers 45 and 46 are located adjacent right and left ears of the driver, so that the alarm sounds produced by the right and left speakers 45 and 46 enter the right and left ears of the driver, respectively. The right and left ear sound data, as described above, are so prepared as to produce the virtual sound source at a location of one of the sensors 11 to 15 detecting an obstacle around the system vehicle. The driver, thus, feels the alarm sound to be being outputted from the direction of one of the sensors 11 to 15 detecting the obstacle.

The alarm system of this embodiment has an additional feature that the sound pressures produced by the right and left speakers 45 and 46 may be so adjusted as to eliminate the alarm sounds heard by any occupant other than the driver. The realization of the feature of the invention in this embodiment is achieved using only the two speakers 45 and 46, thus allowing the capacity of the memory 22B and cost of the speaker driver (i.e., the D/A converters 31A and 31B and the amplifiers 32A and 32B) to be decreased as compared with the above embodiments.

Instead of the clearance sonar 10 designed to transmit a radar wave and receive a radar echo from a reflective object, the alarm system of each of the above embodiments may use an image processor designed to capture an image of a scene embracing the system vehicle using, for example, a digital camera and analyze the captured image to find a target object.

The production of the virtual sound source at a desired location is achieved by selecting the lag times and amplitudes of the outputs of the speakers 41 to 44, but it may also be achieved by further controlling frequency bands of the outputs of the speakers 41 to 44.

The alarm system of each of the above embodiments may also be designed to measure the distance between the system vehicle and a tracked object through the clearance sonar 10 and change the alarm sound as produced by the virtual sound source as a function of the measured distance in order to have the occupant to perceive the spacing between the system vehicle and the tracked object acoustically. Additionally, the alarm system may also be designed to change the outputs of the speakers 41 to 44 as a function of the measured distance so as to produce the virtual sound source at a location of the tracked object.

Instead of the clearance sonar 10, the alarm system of each of the above embodiments may be designed to have a sensor which monitors an opened state of each door of the system vehicle and a warning event determining circuit which works to determine whether the opened state meets a preselected condition or not. If a positive answer is obtained, the system works to determine a location of one of the doors meeting the preselected condition and produce the virtual sound source at that location. For example, the alarm system has door sensors installed at doors of the system vehicle each of which detects incomplete locking of one of the doors. The alarm controller 20, 20A, or 20B works to determine which of the doors is closed incompletely using outputs of the door sensors and produce the virtual sound source at a location of the incompletely closed door.

Further, instead of the clearance sonar 10, the alarm system of each of the above embodiments may use tire pressure sensors each of which detects an unacceptable drop in pressure of air in one of inflatable tires of the system vehicle below a given level. The alarm controller 20, 20A, or 20B works to determine which of the tires drops in pressure undesirably using outputs of the tire pressure sensors and produce the virtual sound source at a location of the deflated tire.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. An alarm system for a vehicle comprising:
an alarm disposed within a cabin of the vehicle which works to output an alarm sound;
a warning event detector detecting a preselcted warning event associated with the vehicle to provide a warning signal indicative thereof;
a warning location determining circuit responsive to the warning signal from said warning event detector to determine a warning location where the warning event has occurred; and
an alarm controller controlling said alarm to produce a virtual sound source at the warning location as determined by said warning location determining circuit so that a vehicle occupant perceives the alarm sound as being outputted from the virtual sound source.

2. An alarm system as set forth in claim 1, wherein said alarm is made up of a plurality of sound outputting devices which are disposed at different locations within the cabin of the vehicle, and wherein said alarm controller works to actuate the sound outputting devices to output alarm sounds at the different locations to produce the virtual sound source at the warning location as determined by said warning location determining circuit.

3. An alarm system as set forth in claim 2, wherein said warning detector is designed to detect the warning event at each of predetermined different detecting locations of the vehicle, wherein at least one of the detecting locations corresponds to one of the sound outputting devices, and wherein when said warning location determining circuit determines that the at least one of the detecting locations matches the warning location, said alarm controller controls outputs of the sound outputting devices so that the alarm sound produced by said one of the sound outputting devices reaches the occupant of the vehicle earlier than any other alarm sound.

4. An alarm system as set forth in claim 2, wherein said warning detector is designed to detect the warning event at each of predetermined different detecting locations of the vehicle, wherein at least one of the detecting locations corresponds to one of the sound outputting devices, and wherein when said warning location determining circuit determines that the at least one of the detecting locations matches the warning location, said alarm controller controls outputs of the sound outputting devices so that the alarm sound produced by said one of the sound outputting devices reaches the occupant of the vehicle at a sound pressure greater than that of any other alarm sound.

5. An alarm system as set forth in claim 2, wherein said warning detector is designed to detect the warning event at each of a first, a second, and a third detecting locations of the vehicle, wherein the first and second detecting locations correspond to two of the sound outputting devices, and the third detecting location is defined between the first and second detecting locations, and wherein when said warning location determining circuit determines that the third detecting location matches the warning location, said alarm controller controls outputs of the two of the sound outputting devices so that the alarm sounds produced by the two of the sound outputting devices reach the occupant of the vehicle simultaneously, thereby producing the virtual sound source at the third detecting location.

6. An alarm system as set forth in claim 5, wherein said alarm controller controls the outputs of the two of the sound outputting devices so that the sound alarms produced by the two of the sound outputting devices reach the occupant at the same sound pressure.

7. An alarm system as set forth in claim 2, wherein the sound outputting devices are installed at two locations on right and left sides of the occupant, respectively, and wherein said alarm controller controls outputs of the sound outputting devices produced at the two locations so as to establish the virtual sound source at the warning location.

8. An alarm system as set forth in claim 7, wherein the two locations at which the sound outputting devices are installed are defined behind a head of the occupant sitting on a seat of the vehicle.

9. An alarm system as set forth in claim 1, wherein said alarm controller includes a memory storing therein sound data for producing the virtual sound source at each of different portions of the vehicle, a selecting circuit selecting one of the sound data corresponding to the warning location, and a virtual sound source producing circuit working to control said alarm so as to output the alarm sound based on the selected sound data, thereby producing the virtual sound source at the warning location.

10. An alarm system as set forth in claim 9, wherein said sound data stored in the memory is made up of digital signal series.

11. An alarm system as set forth in claim 1, wherein said alarm controller includes a signal processing circuit responsive to the signal outputted from said warning detector to perform a given signal processing operation to output an alarm signal, and wherein said alarm is responsive to the alarm signal to output the alarm sound, thereby producing the virtual sound source at the warning location.

12. An alarm system as set forth in claim 11, wherein said signal processing circuit performs the signal processing operation in a digital form.

13. An alarm system as set forth in claim 12, wherein the signal processing operation performed by said signal processing circuit is a filtering operation, and wherein said signal processing circuit includes a memory storing therein filter coefficients for producing the virtual sound source at each of different portions of the vehicle, a selecting circuit selecting one of the filter coefficients corresponding to the warning location, and a filtering circuit performing the filtering operation on the selected filter coefficient to output the alarm signal to said alarm.

14. An alarm system as set forth in claim 1, wherein said warning event detector is implemented by an obstacle detector which works to track an obstacle existing around the vehicle and produce the warning signal.

15. An alarm system as set forth in claim 14, wherein said obstacle detector includes a transceiver which transmits a signal wave around the vehicle and receives a return of the signal wave from the obstacle and a detecting circuit which measures a time the signal wave takes to travel to and return from the obstacle to detect the obstacle.

16. An alarm system as set forth in claim 15, wherein when the detecting circuit detects the obstacle, said warning location determining circuit determines a mount location where said transceiver is mounted on the vehicle as the warning location, and wherein said alarm controller controls said alarm to produce the virtual sound source at the mount location of said transceiver.

17. An alarm system as set forth in claim 1, wherein said warning event detector includes a door sensor working to monitor an opened state of each of doors of the vehicle and a warning event determining circuit determines that the warning event has occurred when the opened state meets a given condition.

18. An alarm system as set forth in claim 17, wherein when the warning event determining circuit determines that the warning event has occurred, said warning location determining circuit determines a location of one of the doors meeting the given condition as the warning location, and wherein said alarm controller controls said alarm to produce the virtual sound source at the location of the one of the doors.

19. An alarm system as set forth in claim 1, wherein said warning event detector includes a tire air pressure sensor working to monitor a pressure of air in each of inflatable tires of the vehicle and a warning event determining circuit determines that the warning event has occurred when the monitored pressure drops below a given level.

20. An alarm system as set forth in claim 19, wherein when the warning event determining circuit determines that the warning event has occurred, said warning location determining circuit determines a location of one of the tires determined to drop in the pressure below the given level as the warning location, and wherein said alarm controller controls said alarm to produce the virtual sound source at the location of the one of the tires.

21. An alarm system as set forth in claim 1, wherein said alarm controller outputs an alarm control signal to said alarm, and wherein said alarm controller includes a signal combiner working to combine the alarm control signal and an output of an audio device installed in the vehicle to produce a sound signal whereby said alarm reproduces the sound signal.
